(19) United States
(12) Patent Application Publication
(10) Pub. No.: US 2006/0016040 A1
(43) Pub. Date: Jan. 26, 2006

(54) Device for cleaning surfaces, especially of printing machine cylinders

(75) Inventor: Hary Kosciesza, Borchen (DE)

Correspondence Address: RICHARD M. GOLDBERG, 25 EAST SALEM STREET, SUITE 419, HACKENSACK, NJ, 07601, US

(73) Assignee: Technotrans AG, Sassenberg (DE)

(21) Appl. No.: 11/185,171

(22) Filed: Jul. 20, 2005

(30) Foreign Application Priority Data
Jul. 21, 2004 (DE) 10 2004 035 399.9

(51) Int. Cl. B08B 1/00

(52) U.S. Cl. 15/256.51

(57) ABSTRACT

Device for cleaning surfaces, especially printing machine cylinders, with the aid of a cleaning coth which is transported from a supply shaft to a winding shaft for soiled cleaning cloth ad is pressed with the help of a rubber bar against the surface to be cleaned, with a device to rotate the winding shaft, and at the ends of the winding shaft for soiled cleaning cloth there is a free-running bearing, the outer ring of which is in contact with the piston rod of a reset cylinder in such a way that the winding shaft is rotated in the direction of winding when the piston rod moves forward, but is held stationary by the free-running effect when the piston rod moves backwards.

The invention concerns a device for cleaning surfaces, especially of printing machine cylinders, with the aid of a cleaning cloth which is transported from a supply shaft to a winding shaft for soiled cleaning cloth and is pressed with the help of a rubber bar against the surface to be cleaned, with a drive to rotate the winding shaft.

It many cases it has been possible to automate the cleaning of surfaces, whether flat or cylindrical surfaces, by drawing a cleaning cloth, possibly with the addition of cleaning agents, across the surface to be cleaned. The use of a web-shaped, automatically transported cleaning cloth with a large width permits the cleaning of a large surface area. Devices of this type are already known of in connection with the cleaning of printing machine cylinders, for example for cleaning the rubber cylinders used in offset printing machines. The description below will therefore be based essentially on this particular application without this implying any limitation in the subject-matter of the application.

In offset printing machines a cylinder wrapped with a rubber blanket serves to transfer the image onto the actual printing cylinder. Once printing starts, the rubber blanket gradually becomes soiled, essentially with residues of printing ink and dust. These unwanted residues have to be removed from time to time to ensure printing of impeccable quality. It is customary, therefore, to clean the rubber blanket from time to time.

This is usually done with the aid of a cleaning cloth in the form of a piece of web-shaped material which is drawn off a supply shaft and, when soiled, collected on a winding shaft. This cleaning cloth is drawn across the rubber blanket with the application of slight pressure, or vice versa, and once a certain degree of soiling has occurred, is fed forward step by step or continuously, and is wound up again.

For the purpose of pressing the cleaning cloth against the rubber blanket a rubber bar is used which extends across the entire length of the rubber blanket cylinder. As a rubber bar possesses no appreciable resistance to bending, the rubber bar is disposed on, and attached to, a support bar in the form of a metal or plastic profile configured to be as stiff as possible.

As the cleaning cloth absorbs the dirt removed from the rubber cylinder, it gradually becomes dirtier itself. When the cleaning cloth has absorbed a certain amount of dirt from the rubber blanket, it is moved forward and wound onto the winding shaft as a result of the winding shaft being rotated, whilst at the same time being unwound from the supply shaft in an equal quantity. This necessitates a drive for the winding shaft.

The winding shaft is usually rotated by motors with suitable gears. The motors used have to be large enough to supply the relatively high torque required to pull the cleaning cloth through the cleaning position and then wind up the cleaning cloth. Furthermore, the motors which are usually used do not readily offer any means of knowing what length of soiled cleaning cloth has already been wound up, unless relatively costly servomotors are used.

The invention is therefore based on the task of creating a device of the above-mentioned type which, with simple means and relatively low costs, allows the length of already wound-up soiled cleaning cloth to be monitored and hence indicate in this way the remaining supply of cleaning cloth and the end thereof.

For the purpose of solving this task, the device according to the invention is characterised in that at each end of the winding shaft for soiled cleaning cloth there is a free-running bearing (bearing with non-reverse ratchet mechanism), the outer ring of which is in contact with the piston rod of a reset cylinder in such a way that the winding shaft is rotated in the direct of winding when the piston rod moves forward but is held stationary by the free-running effect when the piston rod moves backwards.

According to the invention the winding shaft can therefore be made to rotate with relatively simple fluid cylinders, in particular air cylinders.

These are substantially less costly than motors with equivalent driving power and associated control electronics. The stroke of the piston rod of the reset cylinder can be converted relatively easily into rotation angles of the winding shaft. Suitable tests can then be carried out to ascertain what lengths of cleaning cloth have already been wound up so that information concerning how much cleaning cloth is still available, and when the supply will be expended, can be displayed.

Attached to the outer ring of the free-running bearing there is preferably a lever with which the piston rod of the reset cylinder is connected.

This allows the driving force of the cylinder to be transmitted in such a way that a smaller-sized reset cylinder can be used. The strokes of the reset cylinder can be relatively easily detected and communicated to a central control element by end switches, reed switches or similar equipment.

Preferably provided at each end of the supply shaft there is a toothed ratchet wheel whose pawl is released each time the reset cylinder moves forward and then re-engages thanks to spring pretensioning after the reset cylinder moves backward. In this way the supply shaft is kept blocked outside each reset phase of the cleaning cloth so that unintentional unwinding of the cleaning cloth cannot occur.

Preferred embodiments of the invention will be described below with reference to the enclosed drawings, in which

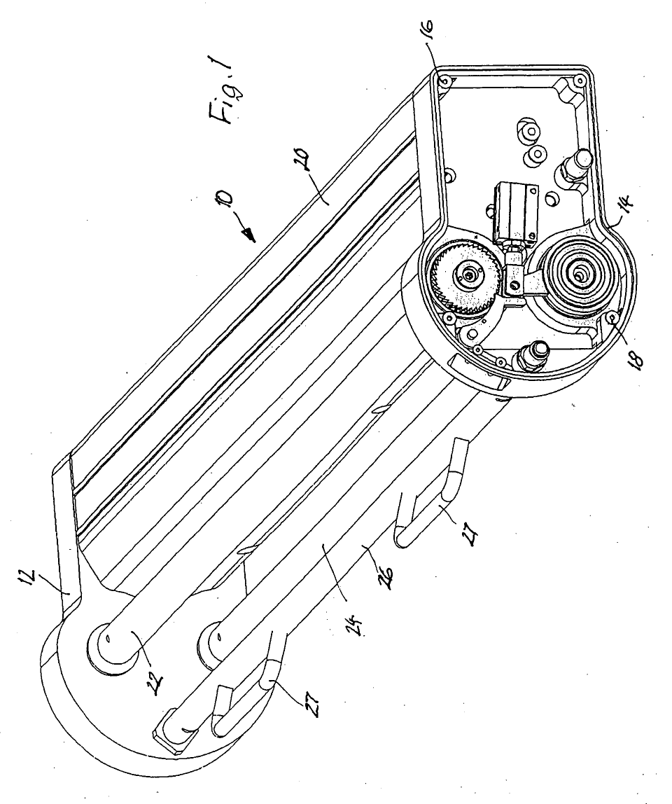

FIG. 1 is a perspective overall view of a device according to the invention;

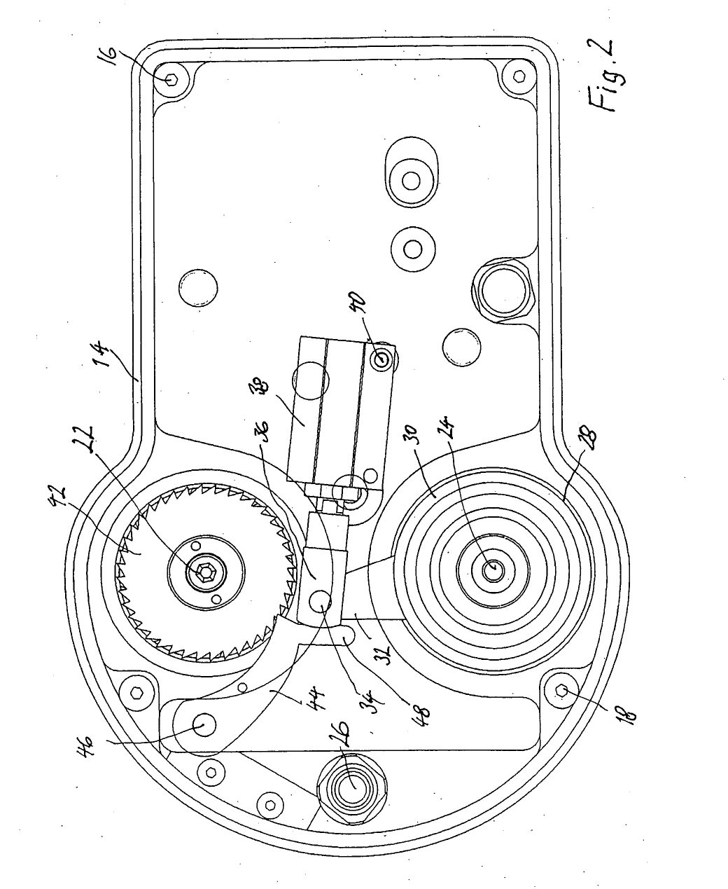

FIG. 2 is a similar view, but shows the drive according to the device for the winding shaft.

A device according to the invention has a housing designated overall as 10, which is an elongated box-shaped structure whose length is the same as the length of the associated rubber blanket cylinder (not shown).

The inside of head element 14 houses the elements of the drive for the winding shaft 24, more details of which will be given below.

Head elements 12,14 are attached to both outer ends. The head element 14 positioned in the forefront of FIG. 1 is shown uncovered. Screw channels 16,18 serve to accommodate screws to attach a cover (not shown here).

Head elements 12,14 project parallel to each other over the elongated centre element 20 of housing 10. Extending between the head elements there is a supply shaft 22 for a supply reel (not shown) of a cleaning cloth, a winding shaft 24 to accommodate soiled cleaning cloth after contact with the rubber blanket (not shown), and a stiffening rod 26. The stiffening rod 26 facilitates the handling of the device and may be provided with handles 27.

The cleaning cloth (not shown) is pulled from the supply shaft 22 around the elongated centre part 20 of housing 10 then back down underneath this centre part and on to winding shaft 26 for soiled cleaning cloth.

FIG. 2 shows a view of the inside of the front head element 14 in FIG. 1. A free-running bearing 28 is attached to the end of winding shaft 24. The outer ring of the free-running bearing is designated as 30. When this outer ring 30 is rotated anticlockwise the winding shaft 24 is also rotated anticlockwise. When outer ring 30 is rotated backwards, winding shaft 24 remains stationary.

Attached to outer ring 30 there is a radially projecting lever arm 32. The outer end of this lever arm 32 is connected via an articulation 34 to the outer end of the piston rod 36 of a reset cylinder 38. The housing of this reset cylinder 38 is fixed to the housing of the device in an axis 40 and can thus be pivoted up and down in FIG. 1 to adjust to the arc-shaped path of lever arm 32.

The stroke of the piston (not shown) of the reset cylinder 38 can be monitored in an appropriate way, e.g. with the help of end switches, teed switches, etc. From the stroke executed by the reset cylinder 38 the rotation angle of winding shaft 24 can be calculated for each stroke, or determined by means of tests. The stroke of the piston (not shown) of reset cylinder 38 can be continuously recorded and in this way it is relatively easy to ascertain what length of cleaning cloth has already been wound up and what length of unsoiled cleaning cloth remains on supply shaft 22.

On supply shaft 22 there is a ratchet wheel 42, in whose teeth a pawl 44 engages, said pawl being pivotably mounted in axis 46. The pawl 44 is spring pretensioned in the direction of ratchet wheel 42 in a manner not shown. This prevents the cleaning cloth on supply shaft 22 from being unwound in an uncontrolled manner. The cleaning cloth is thus held taut on its way from supply shaft 22 to winding shaft 24 and around the centre part 20 of the housing.

At its free end, pawl 44 has a downward pointing arm 48 which is contacted by the advancing piston rod 36 in such a way that, when winding shaft 24 is rotated with the help of reset cylinder 38, pawl 44 is released from the ratchet wheel and the ratchet wheel 42 is free to rotate together with supply shaft 22.

What is claimed is:

1. Device for cleaning surfaces comprising:
a supply shaft which holds a supply of a cleaning cloth,
a winding shaft which holds soiled cleaning cloth which has been transported from the supply shaft and pressed against a surface to be cleaned,
a rubber bar which presses the transported cleaning cloth against the surface to be cleaned,
a free-running bearing at ends of the winding shaft which holds the soiled cleaning cloth there, the free-running bearing including an outer ring, and
a drive for rotating the winding shaft, the drive including a reset cylinder including a piston rod in contact with the outer ring in such a way that the winding shaft is rotated in a winding direction when the piston rod moves forward, but is held stationary by a free-running effect of the free-running bearing when the piston rod moves backwards.

2. The device of claim 1, further comprising a cloth length measuring system associated with the reset cylinder.

3. The device of claim 1, further comprising a radially projecting lever arm attached to the outer ring of free-running bearing, and wherein the radially projecting lever arm is connected via an articulation with the piston rod of the reset cylinder.

4. The device of claim 3, further comprising a housing, and wherein the reset cylinder is pivotally mounted on an axis in the housing of the device.

5. The device of claim 1, further comprising:
a ratchet wheel attached to the supply shaft, and
a spring pretensioned pawl which engages the ratchet wheel.

6. The device of claim 5, further comprising a piston rod for releasing the pawl from a blocked position in relation to the ratchet wheel when the piston rod moves forward.

7. The device of claim 1, wherein the surface to be cleaned is a printing machine cylinder.
